(19) United States
(12) Patent Application Publication
(10) Pub. No.: US 2003/0060107 A1
(43) Pub. Date: Mar. 27, 2003

(54) Thermal blanket including a radiation layer

(76) Inventor: Robert M. Gooliak, Malibu, CA (US)

Correspondence Address: Leland K. Jordan, 1235 Thunder Hill Road, Lincoln University, PA, 19352, US

(21) Appl. No.: 10/238,413

(22) Filed: Sep. 10, 2002

Related U.S. Application Data
(60) Provisional application No. 60/323,933, filed on Sep. 21, 2001.

(51) Int. Cl. B32B 27/12; B32B 17/02; B32B 11/00; B32B 27/04; B32B 5/02; B32B 9/00; B32B 3/00

(52) U.S. Cl. 442/131; 442/178; 442/179; 442/172; 442/133; 442/6; 442/43

(57) ABSTRACT

A thermal management system utilizing a composite thermal radiation barrier comprising alternating layers of a carbon cloth insulating layer and a silica-based organic cloth to reduce the temperatures experienced by the insulating layer.

This application claims the benefit of U.S. Provisional Application No. 60/323,933, filed Sep. 21, 2001.

### FIELD OF THE INVENTION

The present invention relates to a heat resistant insulation blanket used to control heat energy produced within vehicles, ships, aircraft, and similar machines. More particularly, the present invention provides a thermal insulation blanket comprising a primary insulation layer and a radiation barrier with adjoining insulation layers of a reflective metallic mesh and of silica fabric layer coated with silicone.

### BACKGROUND OF THE INVENTION

Insulation blankets and panels have been used for many years to control effects of heat generated by engines, exhaust components, furnaces, any auxiliary power unit, fuel-burning heaters, and other combustion equipment intended for in transit use. For example, in aircraft, the combustion, turbine, and tailpipe sections of turbine engines must be isolated from the rest of the aircraft by a properly rated fire wall. In ships, the oil-burning furnaces and steam generators must be isolated from the rest of the ship by a properly rated fire wall and overhead. In automobiles, heat generated by combustion engines must be prevented from reaching passenger compartments and heat must be retained within catalytic converters in order to maintain efficiency.

A typical fabricated insulation blanket consists of a non-woven fiber blanket insulation layer usually made of fiber glass or ceramic fiber in conjunction with a high temperature resistant woven fabric outer layer. The non-woven is also supported on one side by a knitted or woven metal mesh or foil. The assembly is then linked together by sewing with high temperature resistant thread or by the use of assembly rings. Alternatively inner and outer metal foil skins may be formed with the non-woven layer in between. The assembly is sealed by crimping the inner and outer skins together at the outer edge or by seam welding. The thermal performance of these blankets is limited to the maximum operating temperature of the non-woven layer as it makes up the bulk of the thermal insulation medium. Additionally the temperature differential between the hot side of the insulated article and the cold side outer surface of the blanket is determined by the thermal conductivity of the basic insulation layer. Design of any improved thermal blanket also must take into consideration other elements such as cost, environmental performance, longevity, safety, ease of installation and traditional factors like thermal performance (delta Temperature between surfaces) and temperature resistance.

Overall thermal conductivity is represented by a thermal conductivity coefficient (k) and is the sum of three methods of heat transfer, convection, conduction and radiation. Whereas single layer non-woven insulation systems provide a measurable degree of resistance to heat flow from conduction and convection, resistance to heat flow by radiation may be influenced by radiation barriers. These are separate insulation layers used in conjunction with the primary insulation layer to restrict heat flow via radiation. While in of themselves they may not be appropriate as a primary insulation layer they have specific properties that allow the insulation blanket to perform better with their incorporation. Improving the thermal performance of the radiation barrier is a key factor in improving the state of art in thermal management systems and is an objective of the present invention.

Insulating materials generally comprise multicomponent systems whose structure is known to be composed of solid particles and gas volumes. Due to the favorable design and arrangement of these components in the cross section, the insulating effect is generated by small gas occlusions. It is known that the effective thermal conductivity of a material consists of the heat conduction of the solid matter and the effective thermal conductivity of the occluded gas. This results from the shares of the apparent thermal conductivities caused by convection and radiation within the structure and the thermal conductivity of the occluded gas.

U.S. Pat. No. 6,279,875 provides a thermal blanket for use in connection with a spacecraft or spacecraft component for providing a thermal control coating. The thermal blanket includes a plastic substrate on which is deposited a silicon film by a vacuum deposition process. The silicon film provides a relatively high infrared light transmission and moderate absorption of high energy bandwidths in the solar spectrum that allows for the reflectance of high energy visible light and the emittance of infrared radiation.

U.S. Pat. No. 6,041,595 provides a fiberglass-based insulation blanket applied around the exhaust manifold of an internal combustion engine to maintain higher exhaust gas temperature in the manifold, to enhance oxidation of unburned hydrocarbons and also to reduce ambient air contact with the exterior of the manifold thereby reducing passive formation of nitrous gases.

U.S. Pat. No. 5,388,637 discloses an integral adsorbent-heat exchanger apparatus for use in ammonia refrigerant heat pump systems. The apparatus has a finned tube heat exchange member. A bonded, pyrolyzed activated carbon adsorbent matrix, formed from a mixture of activated carbon particles and resol bonder, is joined to the fins and the tube to form an integral apparatus. The integral apparatus is capable of withstanding repetitive adsorption and desorption cycles without the matrix becoming unbonded and without the matrix becoming unadjoined from the fins and tube. The apparatus permits very high rates of adsorption and desorption of refrigerant and very high rates of heat transfer between the refrigerant and the heat transfer fluid.

U.S. Pat. No. 5,074,090 discloses a self-supportive reflective insulation unit. The insulation unit consists of a metal, foil-covered corrugated cardboard structure of a rectangular shape. The insulation unit further includes a plurality of reflective sheets and insulating sheets for inhibiting the transfer of heat and the transfer of flames between insulation units. Reflective sheets are made of metal foil covered material, such as aluminum. Insulation sheets are made of fire-retardant materials. The insulation units are used in a stacking formation to make a fire wall.

U.S. Pat. No. 4,973,506 discloses a composite insulation block or plate for the facing of a building. The composite plate is used for fire protection having fire insulation properties. The composite plate includes a honeycomb core layer; front and rear inner layers made of an epoxy resin laminate or aluminum; a decorative outer panel made of silicate; and a protective rear plate made of wallastonite and bonded with calcium silicate and mica.

U.S. Pat. No. 4,876,134 discloses a laminated panel having a stainless steel foil core for use in walls and floors, as an insulation barrier, which is used in ships and aircraft. This stainless steel core is formed into a honeycomb configuration by the laminating of a plurality of multi-layered folded sheets of stainless steel. The laminating is done by the use of an adhesive between each of the folded sheets, which then forms the honeycombed core.

U.S. Pat. No. 4,567,076 discloses a composite material structure with an integrated insulating blanket therein. The composite material structure includes a honeycomb core layer and laminate layers made from an epoxy matrix reinforced by graphite fibers. The insulation blanket includes a layer of insulation fill made of ceramic material; an inner face sheet made of a thermosetting matrix material; and an outer face sheet made of a woven ceramic fabric.

U.S. Pat. No. 4,499,208 provides for the heat capacity of activated carbon adsorbent pellets to be enhanced by the mixing of activated carbon powder with a higher heat capacity, inert inorganic material, such as dense alumina, prior to pelletizing. The resulting doped adsorbent enhances the operation of adiabatic pressure swing adsorption processes by decreasing the cyclic temperature change in the adsorbent bed during each processing cycle of the process.

Insulation systems like those found in U.S. Pat. Nos. 3,647,194; 3,804,585; 4,070,151; 4,134,721 and 4,528,672 have utilized preformed refractory members welded directly to water-cooled pipes used as structural members within steel processing re-heat furnaces. U.S. Pat. Nos. 3,941,160 and 4,228,826 disclose interlocking, refractory members for covering and insulating pipes.

Blankets made from ceramic fibers have been substituted for such refractory members. Ceramic fiber blankets have a felt or wool-like texture and flexibility that gives blankets resistance to thermal and bending stresses that occur in many high temperature applications. U.S. Pat. No. 3,820,947 discloses a fibrous ceramic insulating blanket that is wrapped about a pipe and pressed over anchor studs that project from the pipe.

### SUMMARY OF THE INVENTION

In many modern applications, known insulation blankets or panels are impractical or provide reduced performance for many reasons, such as, weight, thickness, or durability of the materials used. The present invention improves on that state of the art by providing a product for providing fire resistance and thermal insulation, consisting of a metallic foil encapsulated non-woven insulation blanket layer consisting essentially of layers of a woven silica-based cloth and a carbon radiation barrier. This new and improved thermal blanket is a flexible composite, removable thermal blanket using a combination of insulation and other materials that cost-effectively provides an optimum combination of thermal resistivity, radiation resistance, user safety and blanket longevity. A key factor in designing an improved thermal blanket is increasing the thermal resistivity of the non-woven carbon radiation barrier layer so that the blanket as a whole may provide even higher temperature resistance. This is accomplished as provided by the present invention by using a composite thermal radiation barrier comprising alternating layers of a carbon cloth insulating layer and a silica-based organic cloth to enhance the temperature management by the insulating layers. Accordingly, this invention provides for a ceramic fiber composite material that overcomes many problems associated with conventional techniques in the art.

The improved insulation blanket of the present invention has allowed a turbo air inlet of a turbo-charged automobile engine to run approximately 15 degrees Fahrenheit cooler because of the improvement in thermal conductivity due to the carbon radiation barrier layer.

The present invention has provided a thermal blanket constructed using about 0.25 inches non-woven silica fiber insulation and a radiation barrier of about 0.125 inches carbon fiber non-woven blanket to enhance the performance of catalytic converters.

The improved insulation blanket of the present invention has enabled a lower surface temperature on an inside automobile door thermoplastic panel than did a conventional fiberglass blanket, thereby resolving a high performance automobile exhaust system failure arising from a heat transfer problem when heat from the exhaust caused an area on the under body close to the inside door panel to heat beyond a point that the thermoplastic molded panel could fail during operation.

The final aspect of the invention includes the process for producing the product itself. Insulation blankets like that of the present invention may be fabricated utilizing a carbon fabric radiation barrier. In most cases a primary insulation layer is chosen for its insulation properties, maximum and minimum temperature performance, environmental factors, cost, etc. The carbon layer or layers are designed into the blanket to provide a synergistic effect with the primary insulation layer because of the carbon fiber layer's ability to block thermal transfer by radiation. A silica cloth layer treated with silicone enhances the effective thermal conductivity of the occluded gases within the carbon layer(s).

### BRIEF DESCRIPTION OF THE FIGURES

FIG. 1 is a schematic cross-section illustrating the thermal blanket of the present invention as it might be applied over relatively flat surfaces to be insulated;

FIG. 2 is a schematic cross-section illustrating the thermal blanket of the present invention as it might be applied over relatively round surfaces to be insulated;

FIG. 3 is a schematic cross-section illustrating a alternate embodiment of the thermal blanket of the present invention, and,

FIG. 3A is a schematic cross-section illustrating a alternate embodiment of the thermal blanket of FIG. 3.

### DETAILED DESCRIPTION OF THE PREFERRED EMBODIMENTS

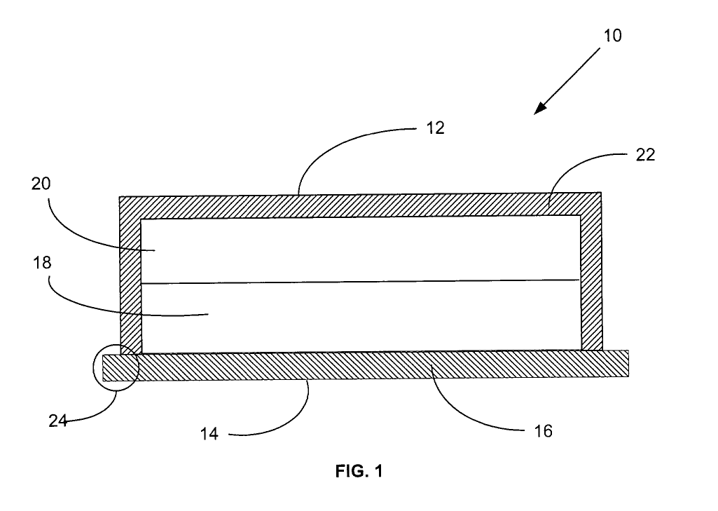

As seen in FIG. 1, the thermal insulation blanket 10 of the present invention comprises a two-sided blanket 10 having a “bottom side” 14 placed adjacent the heat source to be insulated and a “top side” 12 adjacent the environment to be thermally protected. FIG. 1 shows an exemplary 4-layer thermal blanket 10 as preferably made of a heat-resistant, flexible metallic woven or knit mesh layer 16 which is finished as a reflective barrier against radiant heat. Next adjacent to metallic layer 16 is a conventional primary insulation layer 18 comprising silica, or silicon dioxide, a compound of two elements in the earth's crust, silicon and oxygen, SiO_{2,} occurring in crystalline, amorphous, and impure forms. Next adjacent to the primary insulation layer 18 is a radiation barrier layer 20 comprising a non-woven carbon cloth layer. Carbon fiber woven and non-woven fabrics are know to be made by entangling short fibers as opposed to weaving long fibers or yarns of carbon. Next adjacent to radiation barrier layer 20 is an encapsulation layer 22 formed of silica fiber coated with a polymeric organic compound like silicone, and draped around primary insulation layer 18 and radiation barrier layer 20 so as to hold the primary insulation layer 18 and radiation barrier layer 20 in position. Silica fiber is fibrous glass converted to 96% minimum SiO₂ using well-known chemical means. A key factor in the present invention is the addition of organic materials within the silica fiber encapsulation layer 22 in order to enhance the thermal conductivity of the occluded gases and allow the surrounding carbon cloth materials to serve as improved insulating materials. The organic materials within encapsulation layer 22 may be applied using any of several techniques, including coating, brushing and spraying. The disclosed concept of introducing organic materials within encapsulation layer 22 has the net effect of reducing experiential temperatures to create a previously unavailable high temperature thermally resistive insulation blanket 10, like that of the present invention.

In an operating example of the use of thermal blanket 10, in an instance that space limitations around portions of the system to be insulated require that the maximum thickness of blanket 10 be less than about 0.5 inches, a typical Thermal Insulation performance of delta T=330 degrees Fahrenheit is often required to be achieved. Delta T is well know to be the difference in temperature between the hot and cold faces of the system portion to be insulated in an insulated versus un-insulated conditions. In this example, primary insulation layer 18 comprises a commercially available large diameter mineral fiber insulation of thickness about 0.25 inches known as SFB 200 or 250 available from Carbon Cloth Technologies, Malibu, Calif. The SFB 200 series materials are advantageously useful because of their very high thermal resistivity. Typically exhaust system portions have a hot side temperature of about 550 degrees Fahrenheit. Selecting radiation barrier layer 20 as comprising a carbon fiber non-woven layer of thickness about 0.125 inches, for example NW2 insulation available from Carbon Cloth Technologies, provides a more cost-effective blanket 10 as opposed to more tradition radiation barrier materials such as stainless steel foil and the like. A key factor in the performance of blanket 10 is the selection of encapsulation layer 22 as comprising a silicon fiber cloth like SFC, also available from Carbon Cloth Technologies, with an additional silicone rubber coating, envisioned by the present invention. Blanket 10 may be most readily fabricated by wet rolling or casting or laminating and then air drying a thin 2 mil layer of silicone and weighing about 2-3 ounces per square yard of material. In making this critical selection of composite materials, a traditional glass fabric could be been used at a lower cost, however the preferred silicon fiber cloth layer has a thermal resistivity 16 times greater than that of glass. Finally, flexible metallic woven or knit mesh layer 16 is preferably formed of Inconel™ metal or stainless steel with a thickness of about 0.01 inches. Using these preferred thermal blanket materials, the R-value of thermal blanket 10 at a thickness of 0.5 inches is approximately 17 for a hot side temperature of about 550 degrees Fahrenheit.

Insulating materials may create health and safety concerns for personnel who install and/or remove thermal blankets, or in the case of transportation are exposed to health hazards created by insulating materials. Furthermore, some traditional insulating materials may break down after exposure to heat and environmental stress and produce hazardous decomposition products. The design of blanket 10 as described above avoids the more traditional use of ceramic fiber as the primary insulation layer 18 thereby providing increased safety performance since ceramic fibers of less than about 2 microns have been linked to pulmonary disease. Likewise, the design of blanket 10 as described above avoids the more traditional use of non-woven fiberglass as the primary insulation layer 18 thereby providing increased safety performance since fiberglass is known to degrade after repeated heat cycles upon wetting causing safety and health hazards. Other traditional insulation materials like rock wool, basalt fiber and calcium silicate may also have similar safety and health hazards.

Exhaust system component portions are subject to long periods of vibration and to repeated exposures to various chemicals like road salt, engine oils and lubricants. Ceramic fiber blanket materials are known to physically degrade in insulating exhaust systems because the small weak fibers are not resistant to vibration. Even more serious is the chemical reaction of glass fibers with road salts and other contaminants which causes the fibers to lose their insulation characteristics along with subsequent physical deterioration. Similarly, an outer shell of fiberglass woven cloth will also become physically weakened after a number of heating and cooling cycles upon becoming wet as happens in exhaust system applications. As seen in FIG. 1, blanket 10 is preferably made of carbon cloth materials without the use of fiberglass or ceramic materials in order to avoid such thermal failure modes thereby providing higher resistance to vibrational and environmental degradation. Similarly, other traditional and more conventional insulation materials like Nomex® polymer has low temperature resistance, polyimides have high water absorption, polyurethanes have poor fungus resistance and aluminum has poor corrosion resistance. In experience, blanket 10 of the present invention has a thermal resistivity of about 10% higher than previously known thermal blankets made using similar materials but without the silicone coating which has the advantage of affording higher protection to the conventional materials of construction, thereby increasing their stability in use, in particular in harsh environments like found in typical exhaust applications and road use.

FIG. 1 shows a thermal blanket 10 in a laid-out flat position before installation suitable for use in controlling temperatures associated with an internal combustion engine. Due to several factors, including time and gaseous flow constraints, the combustion of hydrocarbons in an internal combustion engine is not fully completed. Consequently, a small amount of fuel and lubricating oil exits the combustion portion of the engine through an exhaust manifold in an un-oxidized state. However, if oxygen remains in the exhausted gases and if the exhausted gases are at a sufficiently high temperature for a sufficient residence time within the exhaust ports and manifolds, oxidation may continue. One purpose of the insulation blanket 10 of the present invention is to increase the exhaust gas temperature in the exhaust manifold system by insulating it and thus decreasing the heat transfer from the exhaust to the outside air. The increased exhaust gas temperature will, in turn, promote increased oxidation of unburned hydrocarbons, thus lowering total hydrocarbon emissions. Because of the presence of an outermost layer containing silicone in layer 22, blanket 10 of the present invention increases fire protection since the silicone materials of construction do not combust or burn but more safely, simply smoke without flaming.

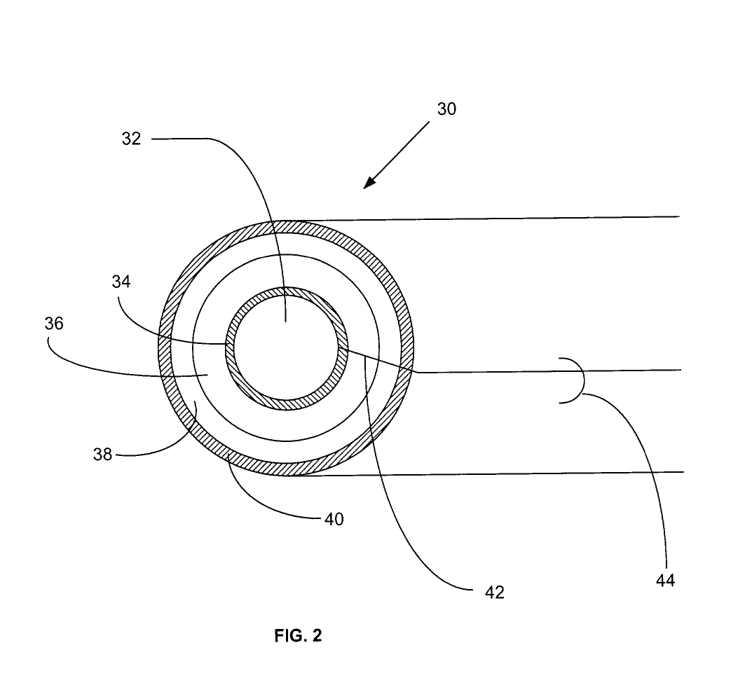

The insulation blanket 10 comprises carbon cloth in a composite with various other organic materials and may be trimmed and shaped to be applied conventionally around the exhaust manifold system. Blanket 10 is trimmed if necessary to enclose relatively flat portions of the manifold system and may be fastened by means of pop rivets, metal thread and the like. Preferably stainless steel retention springs are used to aid in installation. FIG. 2 shows how the thermal blanket of the present invention might be applied as a thermal wrap blanket 30 over relatively round surfaces, like exhaust pipes, to be insulated. Thermal wrap blanket 30 substantially lowers the heat transfer rate from the exhaust manifold to the engine compartment environment, thus increasing the exhaust gas temperature in exhaust manifold. It is necessary to retain heat in the exhaust system in order to engage the catalytic converter filtration element. The blanket 30 further reduces hydrocarbons by increasing the rate of temperature rise within the exhaust manifold immediately after starting an engine, when hydrocarbons are at their highest concentration.

The design of blanket 10 as seen in FIG. 1 also allows it to be installed very easily. Stainless steel retention springs 24 are employed to make a custom fit easily achieved. Using a 4-sided design allows an installer to encase an exhaust system in sections while gradually working along the length of the system. Traditional and less expensive metal-shell crimped are difficult to install to the point where it may be installed inside out or reversed end-to-end. Using stainless steel retention springs 24 is also more effective than the use of more traditional retaining springs and lacing wire which have been known to lead to catastrophic failure during operation.

The exhaust manifold should be insulated for several reasons, including maintaining higher temperature in the exhaust manifold which enhances the oxidation of unburned hydrocarbons in the exhaust gas. As seen in FIG. 2, a thermal blanket wrap 30 envisioned by the present invention may be provided in the form of a tape which can be wrapped around tube-like exhaust system portions and the connecting tubes thereto and avoid these problems. In FIG. 2, tube 32 represents the high temperature portion to be insulated; layer 34 is a wrapped flexible metallic woven or knit mesh layer for example Inconel™ metal mesh; layer 36 is a wrapped primary insulation blanket layer which is preferably a large diameter mineral fiber insulation layer of previously described SFB 250; layer 38 is a wrapped carbon fiber radiation barrier, preferably previously described NW2 insulation; and, layer 40 is a wrapped layer of silica fabric treated with silicone. The blanket wrapping split line is indicated by 42 which is sealed using a number of fasteners 44, which may be low-profile Q-pins with a J-hook or similar hooks or clamps or thread, all preferably of stainless steel or Inconel™ metals.

The production of thermal insulation blanket 10 and thermal blanket wrap 30 like that of the present invention uses a carbon layer or multiple layers to provide a synergistic effect with the primary insulation layer because of the carbon fiber layer's ability to block thermal transfer by radiation. From the hot side to the cold side, thermal insulation blanket 10 and wrap 30 or blanket 50 described hereinafter, may be fabricated using any appropriate combination of the following:

1. Inconel™ metal knitted mesh layer 16, silica fiber non-woven layer 18, carbon fiber non-woven layer 20, and importantly, woven silica fabric layer 22 treated with silicone as described above. The layers may be assembled by means of sewing with Inconel™ metal or quartz sewing thread. The blanket may be attached to the article being insulated with tie wire or clamps.

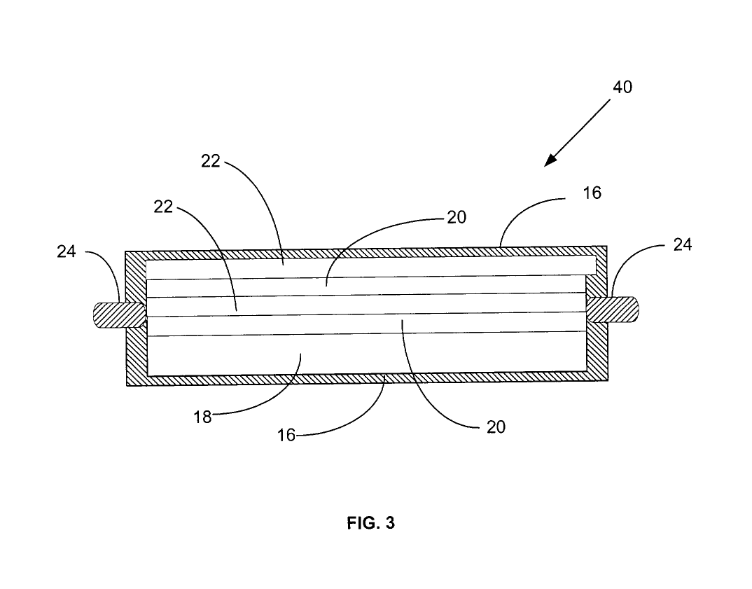

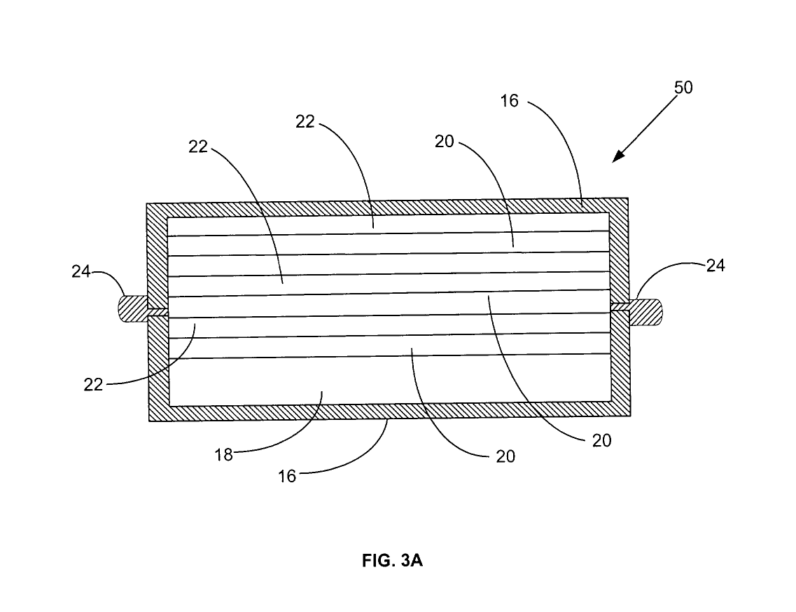

2. Formed stainless steel foil layer 16, silica fiber woven cloth layer 18, carbon fiber woven cloth layer 20, and alternating layers of silica cloth layer 22 coated as described above with silicone and carbon cloth layer 20 up to 8 total layers as seen in FIG. 3A, encapsulated by another formed stainless steel skin layer 16. The layers may be assembled by means of crimping the stainless steel edges over each other.

An alternate method to produce thermal insulation blanket 10 and wrap 30 in instances where temperatures are not as high as in the case of exhaust systems comprises bonding together a composite of non-woven carbon cloth layer 20 and an organic cloth layer 20 using an adhesive glue. Such an application is suitable for less demanding thermal environments like electronic control modules, wiring harnesses and non-critical structural elements of vehicles.

It is to be understood that the embodiments of the invention disclosed herein are illustrative of the principles of the invention and that other modifications may be employed which are still within the scope of the invention. For example, as shown in FIG. 3, a thermal blanket 50 envisioned by the present invention may employ at least two or more alternating layers of non-woven carbon cloth layer 20 and an organic cloth layer 22 comprising a silica fiber layer containing a polymeric organic compound like silicone, in addition to a conventional primary insulation layer 18 and a pair of conventional metallic layers 16. In such a case, blanket 50 has been tested on an engine dynamometer for 8 hours at 1200 degrees Fahrenheit and found to retain 15% more heat over the time period than conventional thermal materials.

Further, in an instance that there are no space limitations around portions of the system to be insulated, or a Thermal Insulation performance of greater than delta T=330 degrees Fahrenheit is to be achieved, then primary insulation layer 18 could comprise a mineral fiber insulation of thickness about 0.50 inches and radiation barrier layer 20 could comprise a carbon fiber non-woven layer of thickness about 0.25 inches to achieve even higher thermal resistivity. Even further, encapsulation layer 22 could comprise any of the SFC series products available from Carbon Cloth Technologies with a silicone rubber coating having a minimum weight percentage of ???% of silicone added to the SFC materials. Using these alternate preferred thermal blanket materials, the R-value of thermal blanket 10 at a thickness of about 1.0 inches is greater than 17 for a hot side temperature of about 550 degrees Fahrenheit. Applications such as these are useful in shipboard exhaust systems or heating furnace systems and the like where temperature reduction is desired to reduce ambient temperatures.

Alternately thermal insulation blanket 10 and wrap 30 may be used to insulate heat accompanying automotive turbocharge devices. Turbocharged internal combustion engines include an air compressor which delivers compressed air to the engine intake. The air compressor is driven by an exhaust gas turbine which discharges exhaust gas to atmosphere out of an exhaust pipe. Exhaust gas is collected from the cylinder exhaust valves and is delivered through connecting tubes to the exhaust manifold. The exhaust manifold is connected to the exhaust gas turbine, which receives the hot exhaust gas to expand the hot exhaust gas and discharge it. The exhaust manifold may be insulated using thermal insulation wrap 30 in order to deliver higher temperature gas to the turbine thereby increasing the turbine's efficiency.

Accordingly, the present invention is not limited to those embodiments precisely shown and described in the specification but only by the claims.

1. A method for increasing the thermal conductivity of a thermal blanket by the addition of organic materials to an insulating layer in order to increase the thermal conductivity of the occluded gases.

2. The method of claim 1 wherein said insulating layer is formed of silica fiber and said organic materials comprise silicone.

3. The method of claim 2 wherein the silicone coating is about 2 mils in thickness and has a weight of between 2 and 3 ounces per square yard of material.

4. A composite thermal radiation barrier comprising a silica fiber layer having a polymeric organic coating and disposed next adjacent to a carbon cloth layer.

5. The composite thermal radiation barrier of claim 4 further comprising a silica fiber ayer next adjacent to the carbon cloth layer.

6. The composite thermal radiation barrier of claim 4 further comprising a metallic layer.

7. The thermal radiation barrier of claim 4 wherein the polymeric organic compound is silicone applied in an amount sufficient to effectively enhance the thermal conductivity of the occluded gases and allow the carbon cloth layer to serve as improved insulating layer.

8. The thermal radiation barrier of claim 7 wherein the polymeric organic compound is applied by laminating, coating, brushing or spraying at a thickness of about 2 mils and a weight of between 2 and 3 ounces per square yard of said carbon cloth layer.

9. The thermal radiation barrier of claim 3 wherein the carbon cloth layer is a woven or non-woven fabric.

10. A thermal insulation blanket comprising at least two alternating layers of a silica fiber layer containing a polymeric organic compound and a carbon cloth layer.

11. The thermal insulation blanket of claim 10 wherein said eric organic compound is silicone applied by laminating, coating, brushing or spraying at a thickness of about 2 mils and a weight of between 2 and 3 ounces per square yard of said carbon cloth layer.

12. The thermal insulation blanket of claim 10 further comprising a primary insulation layer of silica.

13. The thermal insulation blanket of claim 12 further comprising a heat-resistant, flexible metallic woven or knit mesh layer as a reflective radiation barrier against radiant heat.

14. The thermal insulation blanket of claim 10 wherein the blanket is constructed without including fiberglass or ceramic materials.

15. The thermal insulation blanket of claim 10 wherein an encapsulation layer is draped around the primary insulation layer and radiation barrier layer so as to hold the primary insulation layer and radiation barrier layer secure.
